(19) United States
(12) Patent Application Publication
(10) Pub. No.: US 2020/0005240 A1
(43) Pub. Date: Jan. 2, 2020

(54) DELIVERY PLANNING DEVICE, DELIVERY PLANNING SYSTEM, AND DELIVERY PLANNING METHOD

(71) Applicant: HITACHI, LTD., Tokyo (JP)

(72) Inventors: Sozen KO, Tokyo (JP); Junko HOSODA, Tokyo (JP); Tazu NOMOTO, Tokyo (JP); Takahiro OGURA, Tokyo (JP); Kiyofumi INOUE, Tokyo (JP)

(21) Appl. No.: 16/381,030

(22) Filed: Apr. 11, 2019

(30) Foreign Application Priority Data
Jun. 29, 2018 (JP) 2018-124286

(51) Int. Cl. G06Q 10/08; G06Q 10/04

(52) U.S. Cl. CPC G06Q 10/08355; G06Q 10/047

(57) ABSTRACT

A delivery planning device is provided to efficiently cope with delivery requirements of a loading place, an off-loading place, a cargo amount, a car loading vehicle, and a work shift of a driver that fluidly change. A delivery planning device receives and registers one or more delivery requests relating to deliveries between predetermined points. The delivery requests are divided into deliveries in one or more areas for which drivers of a predetermined number of delivery vehicles are responsible according to the predetermined number of the delivery vehicles; and a vehicle route planning unit specifies a delivery route and a cost relating to deliveries for each combination of a candidate for a relay place between the areas and a relay time in the candidate for the relay place, and specifies the delivery route as a vehicle route using the cost.

### CROSS-REFERENCE TO RELATED APPLICATION

The present application claims priority from Japanese application JP 2018-124286, filed on Jun. 29, 2018, the contents of which is hereby incorporated by reference into this application.

### TECHNICAL FIELD

The present invention relates to a delivery planning device, a delivery planning system, and a delivery planning method.

### BACKGROUND ART

As a background art in this technical field, there is disclosed in JP-A-2018-052660 (PTL 1). PTL 1 describes “A round transport system using a plurality of car loading vehicles from which a head and a chassis are detachable, in which a car is transported while the chassis is switched and towed by the head, the round transport system including: a loading place where the car is loaded to the chassis to be towed by the head; an off-loading place where the car is off-loaded from the chassis towed by the head; and a relay place that is positioned between the loading place and the off-loading place and where the chassis towed by the head is switched, in which a first loop course that connects the loading place and the relay place to each other and a second loop course that connects the relay place and the off-loading place to each other are set, and a control center that divides the heads of the car loading vehicles into a head for loading that travels the first loop course repeatedly for a day and a head for off-loading that travels the second loop course at least once a day and generates a transport schedule is provided.”

### CITATION LIST

### Patent Literature

PTL 1: JP-A-2018-052660

### SUMMARY OF INVENTION

### Technical Problem

The technique described in PTL 1 describes the delivery method in which the two loop courses are joined in the relay place such that the head is relayed between the vehicles. However, this method cannot efficiently deal with delivery requirements where a loading place, an off-loading place, a cargo amount, a car loading vehicle, and a work shift of a driver fluidly change.

An object of the present invention is to provide a device or the like that efficiently deals with delivery requirements where a loading place, an off-loading place, a cargo amount, a car loading vehicle, and a work shift of a driver fluidly change.

### Solution to Problem

The present application includes a plurality of means for solving the problem, and one example thereof is as follows. According to one aspect of the present invention for solving the problem, there is provided a delivery planning device including: a delivery request registering unit that receives and registers one or more delivery requests relating to deliveries between predetermined points; a responsible area generating unit that divides the delivery requests into deliveries in one or more areas for which drivers of a predetermined number of delivery vehicles are responsible according to the predetermined number of the delivery vehicles; and a vehicle route planning unit that specifies a delivery route and a cost relating to deliveries for each combination of a candidate for a relay place between the areas and a relay time in the candidate for the relay place and specifies the delivery route as a vehicle route using the cost.

### Advantageous Effects of Invention

According to the present invention, it is possible to realize a device, a system, and a method that efficiently deal with delivery requirements where a loading place, an off-loading place, a cargo amount, a car loading vehicle, and a work shift of a driver fluidly change. Objects, configurations, and effects other than those described above will be clarified by describing the following embodiments.

### BRIEF DESCRIPTION OF DRAWINGS

FIG. 1 is a diagram illustrating a configuration example of a delivery planning device and a delivery planning system according to a first embodiment of the present invention.

FIG. 2 is a diagram illustrating a data structure example of a delivery request information storing unit.

FIG. 3 is a diagram illustrating a data structure example of a collection information storing unit.

FIG. 4 is a diagram illustrating a data structure example of a delivery information storing unit.

FIG. 5 is a diagram illustrating a data structure example of a vehicle center information storing unit.

FIG. 6 is a diagram illustrating a data structure example of a relay place information storing unit.

FIG. 7 is a diagram illustrating a data structure example of a moving cost information storing unit.

FIG. 8 is a diagram illustrating a data structure example of a vehicle information storing unit.

FIG. 9 is a diagram illustrating a data structure example of a driver information storing unit.

FIG. 10 is a diagram illustrating a data structure example of a delivery request distribution storing unit.

FIG. 11 is a diagram illustrating a data structure example of a travel plan information storing unit.

FIG. 12 is a diagram illustrating a data structure example of a relay pattern evaluation storing unit.

FIG. 13 is a diagram illustrating a data structure example of a work information storing unit.

FIG. 14 is a diagram illustrating a hardware configuration example of the delivery planning device.

FIG. 15 is a diagram illustrating a flow example of a delivery planning process.

FIG. 16 is a diagram illustrating a distribution example of collection places and delivery places.

FIG. 17 is a diagram illustrating a distribution example of collection places, delivery places, and delivery areas.

FIG. 18 is a diagram illustrating examples of vehicle routes depending on relay times.

FIG. 19 is a diagram illustrating a display screen example of the delivery planning device.

FIG. 20 is a diagram illustrating a display screen example of a terminal for owner.

FIG. 21 is a diagram illustrating a display screen example of a terminal for vehicle.

FIG. 22 is a diagram illustrating a display screen example of a terminal for driver.

### DESCRIPTION OF EMBODIMENTS

Hereinafter, an embodiment of the present invention will be described based on the drawings. In all the diagrams for describing the embodiment, basically, the same members are represented by the same reference numerals, and the description thereof will not be repeated. In the following embodiment, it goes without saying that the components (including element steps and the like) are not necessarily required, unless expressly stated otherwise and unless they are considered to be clearly required in principle or other reasons. When referring to “constituted of A”, “composed of A”, “provided with A”, and “including A”, it goes without saying that the elements other than the specified one are not necessarily excluded, unless expressly stated the fact that there is only the particular element, or other reasons. In the following embodiment, when referring to the shape, the positional relationship, or other characteristics of the components and the like, elements that substantially approximate or similar to the shape or other characteristics are included unless expressly stated otherwise and unless they are clearly considered not to be so in principle.

In order to collect and deliver cargos using a plurality of vehicles regarding a plurality of delivery requests in which in-area transports and inter-area transports are mixed, a complex control is required, and it has been common to make a delivery plan having high efficiency using a computer system recently. On the other hand, however, a delivery destination may be very far from an activity area of a driver, or the working hours may be long when the number of delivery cargos reaches its peak. Therefore, a delivery plan considering these points has been expected to be used.

Here, when a delivery destination is far, a method of delivering a cargo to another driver by relay to prevent the same driver from performing a long-distance transport or a method of sharing a delivery vehicle between drivers as short-time workers even in the same delivery area to prevent working hours for delivery from increasing is disclosed.

That is, when a plan can be made by a computer system by separately considering cargos, delivery vehicles, and drivers and efficiently integrating the articles, the delivery vehicles, and the drivers, it can be said that delivery requirements where a loading place, an off-loading place, a cargo amount, a car loading vehicle, and a work shift of a driver fluidly change can be efficiently dealt with considering a working environment of the drivers while realizing on-time delivery.

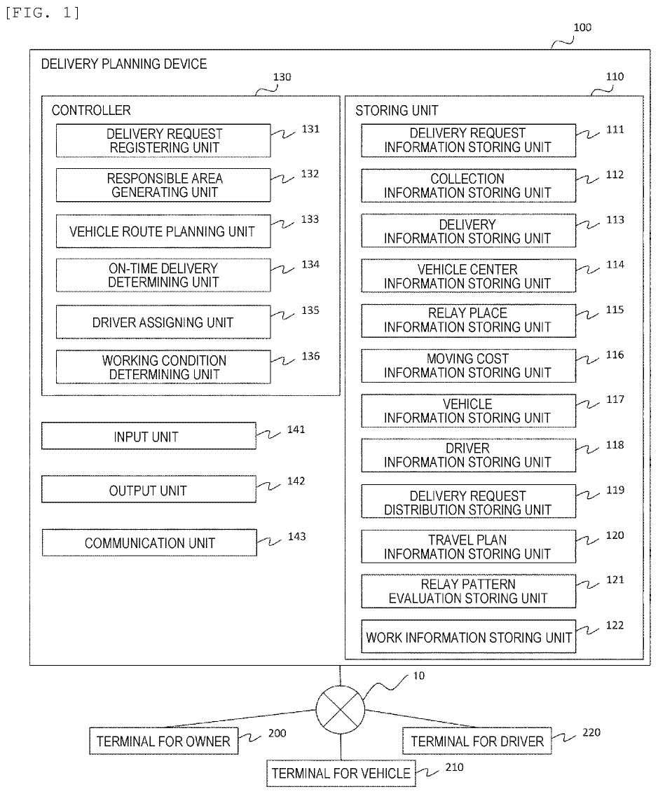

FIG. 1 is a diagram illustrating a configuration example of a delivery planning device according to a first embodiment of the present invention. A delivery planning device 100 includes a storing unit 110, a controller 130, an input unit 141, an output unit 142, and a communication unit 143. The storing unit 110 includes a delivery request information storing unit 111, a collection information storing unit 112, a delivery information storing unit 113, a vehicle center information storing unit 114, a relay place information storing unit 115, a moving cost information storing unit 116, a vehicle information storing unit 117, a driver information storing unit 118, a delivery request distribution storing unit 119, a travel plan information storing unit 120, a relay pattern evaluation storing unit 121, and a work information storing unit 122.

The controller 130 includes a delivery request registering unit 131, a responsible area generating unit 132, a vehicle route planning unit 133, an on-time delivery determining unit 134, a driver assigning unit 135, and a working condition determining unit 136.

The input unit 141 receives an input. The output unit 142 outputs information. The communication unit 143 communicates with other devices including a terminal 200 for owner, a terminal 210 for vehicle, and a terminal 220 for driver through a network 10. The terminal 200 for owner is a so-called personal computer or work station that is used by an owner, and the terminal 210 for vehicle is a vehicle-mounted terminal such as a car navigation device or a tablet terminal. The terminal 220 for driver is a terminal such as a smartphone or a tablet terminal that is carried by driver. Each of the terminal 200 for owner, the terminal 210 for vehicle, and the terminal 220 for driver includes at least a communication unit and a display unit although not shown in the drawings.

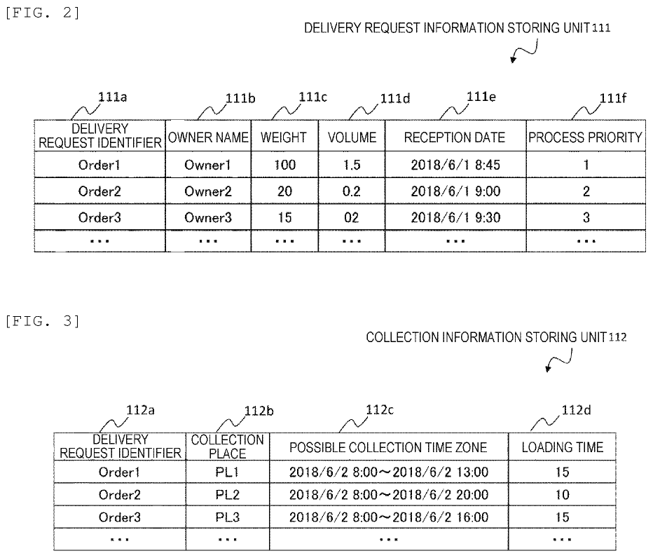

FIG. 2 is a diagram illustrating a data structure example of the delivery request information storing unit. The delivery request information storing unit 111 includes a delivery request identifier 111a, an owner name 111b, a weight 111c, a volume 111d, a reception date 111e, and a process priority 111f.

The delivery request identifier 111a is an identifier that distinguishes one delivery request of a cargo from other delivery requests. The owner name 111b is information for specifying an owner who requests a cargo delivery. The weight 111c and the volume 111d refer to the weight and the volume of a cargo. The reception date 111e is information for specifying the date on which a delivery request of a cargo is received. The process priority 111f is the priority of a process that is assigned according to a predetermined standard in a delivery request. For example, the process priority of a cargo having an early delivery date is high, and the process priority of a cargo having a late delivery date is low. The priorities maybe determined in a predetermined order according to various delivery conditions.

FIG. 3 is a diagram illustrating a data structure example of the collection information storing unit. The collection information storing unit 112 includes a delivery request identifier 112a, a collection place 112b, a possible collection time zone 112c, and a loading time 112d.

The delivery request identifier 112a is an identifier that distinguishes one delivery request of a cargo from other delivery requests. The collection place 112b is a place where a cargo is collected from a consignor to load the cargo on a delivery vehicle. The possible collection time zone 112c is information for specifying a time zone in which a driver can visit a consignor to collect a cargo. The loading time 112d is a period of time required to load a cargo on a delivery vehicle.

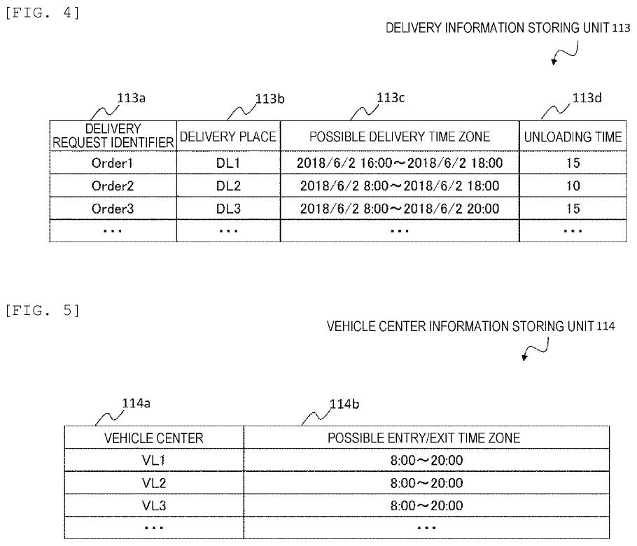

FIG. 4 is a diagram illustrating a data structure example of the delivery information storing unit. The delivery information storing unit 113 includes a delivery request identifier 113a, a delivery place 113b, a possible delivery time zone 113c, and an unloading time 113d.

The delivery request identifier 113a is an identifier that distinguishes one delivery request of a cargo from other delivery requests. The delivery place 113b is a place where a cargo is delivered to a consignee. The possible delivery time zone 113c is information for specifying a time zone in which a driver can visit a consignee to deliver a cargo. The unloading time 113d is a period of time required to unload a cargo from a delivery vehicle and to deliver the cargo to a consignee.

FIG. 5 is a diagram illustrating a data structure example of the vehicle center information storing unit. The vehicle center information storing unit 114 includes a vehicle center 114a and a possible entry/exit time zone 114b.

The vehicle center 114a is an identifier that distinguishes one vehicle center from other vehicle centers. The vehicle center is a delivery point and stores delivery vehicles. A delivery operation starts when a driver gets out from a vehicle center into a delivery vehicle, and the delivery operation ends when the driver gets off from the delivery vehicle to the vehicle center. The possible entry/exit time zone 114b is a time zone in which a delivery vehicle can enter a vehicle center or can exit from a vehicle center. The possible entry/exit time zone 114b matches with a service time zone of a vehicle center.

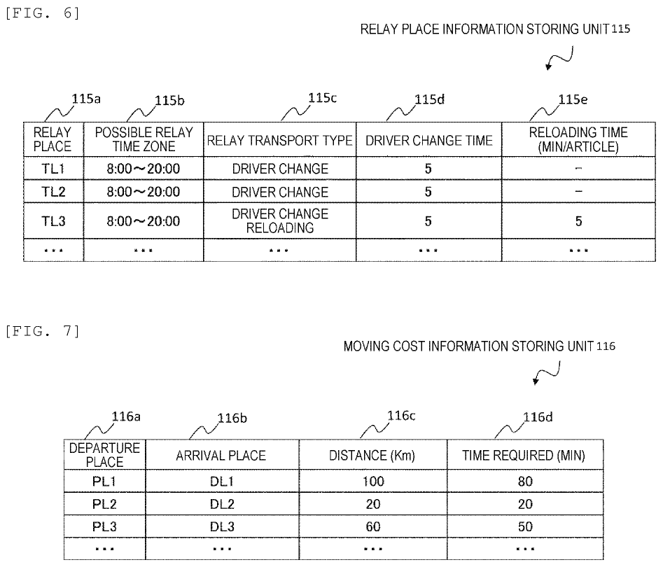

FIG. 6 is a diagram illustrating a data structure example of the relay place information storing unit. The relay place information storing unit 115 includes a relay place 115a, a possible relay time zone 115b, a relay transport type 115c, a driver change time 115d, and a reloading time 115e.

The relay place 115a is information for specifying a position or a facility where relay is performed. As described above, the relay place is a position where, when a delivery destination of a cargo is distant, the driver is changed to another driver such that the cargo is delivered to another driver to prevent the same driver from performing a long-distance transport. The relay place is a position where, when a delivery vehicle between drivers as short-time workers even in the same delivery area to prevent working hours for delivery from increasing, the delivery vehicle is shared.

The possible relay time zone 115b is a time zone in which relay can be performed in the relay place 115a. For example, in a 24-hour relay station, the possible relay time zone 115b corresponds to 24 hours. When relay is performed in a facility where the business hours are predetermined, the possible relay time zone 115b corresponds to the business hours or a time zone that is allowed by a relay facility.

The relay transport type 115c is information for specifying a relay type that can be performed in the corresponding relay place among driver change, cargo reloading, and the like. For example, to perform the cargo reloading, it may be necessary to prepare a certain size of space or a facility or to satisfy safety standards. Therefore, it is necessary to clearly specify the relay type that can be performed.

The driver change time 115d is a period of time required to change a driver. The reloading time 115e is a period of time required to reload one cargo.

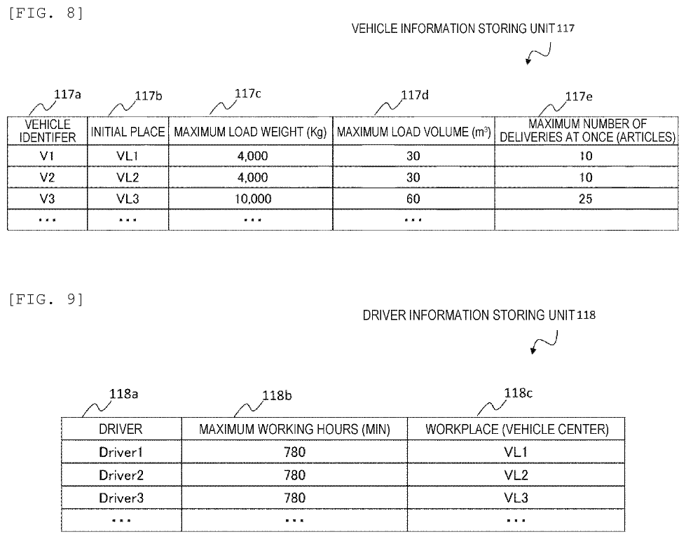

FIG. 7 is a diagram illustrating a data structure example of the moving cost information storing unit. The moving cost information storing unit 116 includes a departure place 116a, an arrival place 116b, a distance 116c, and a time required 116d.

The departure place 116a and the arrival place 116b are information for specifying a departure place and an arrival place. The distance 116c is a moving distance (direct distance or a distance along a path) from the departure place 116a to the arrival place 116b. The time required 116d is a period of time (estimated time) required to move from the departure place 116a to the arrival place 116b.

FIG. 8 is a diagram illustrating a data structure example of the vehicle information storing unit. The vehicle information storing unit 117 includes a vehicle identifier 117a, an initial place 117b, a maximum load weight 117c, a maximum load volume 117d, and a maximum number of joint deliveries 117e.

The vehicle identifier 117a is an identifier that distinguishes one vehicle from other vehicles. The initial place 117b is information for specifying an initial place of a vehicle, typically, any vehicle center that manages the vehicle.

The maximum load weight 117c, the maximum load volume 117d, and the maximum number of joint deliveries 117e are the maximum weight, the maximum load, and the maximum number of cargos to be loaded. A vehicle should not be used for a delivery that exceeds any of the maximum values. For example, when even a light cargo has a large volume, the volume of the cargo to be loaded should not exceed the maximum volume.

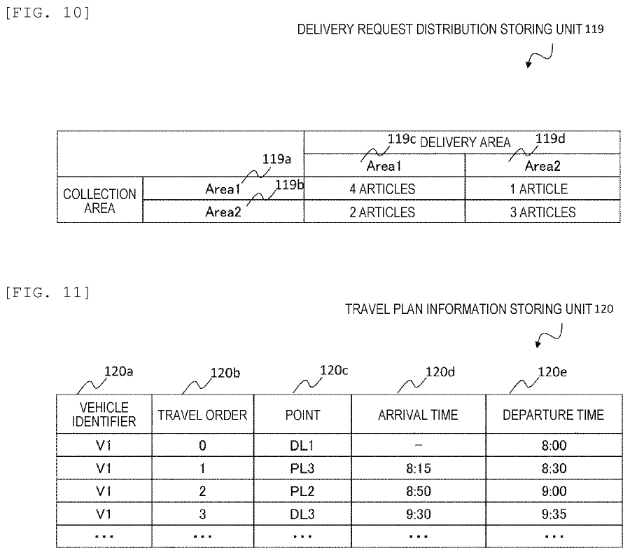

FIG. 9 is a diagram illustrating a data structure example of the driver information storing unit. The driver information storing unit 118 includes a driver 118a, maximum working hours 118b, and a workplace 118c.

The driver 118a is information for specifying a driver who drives a delivery vehicle to collect and deliver a cargo. The maximum working hours 118b are information for specifying the longest working hours per day of the driver specified by the driver 118a. The workplace 118c is information for specifying a position where the driver specified by the driver 118a works, typically any vehicle center.

FIG. 10 is a diagram illustrating a data structure example of the delivery request distribution storing unit. The delivery request distribution storing unit 119 stores the number of delivery cargos for each combination of a collection area and a delivery area. In addition, in the embodiment, areas that function as a collection area and a delivery area may be variable. Therefore, FIG. 10 illustrates an example in which, as identifiers, collection places include “Area1” 119a and “Area2” 119b and delivery areas include “Area1” 119c and “Area2” 119d.

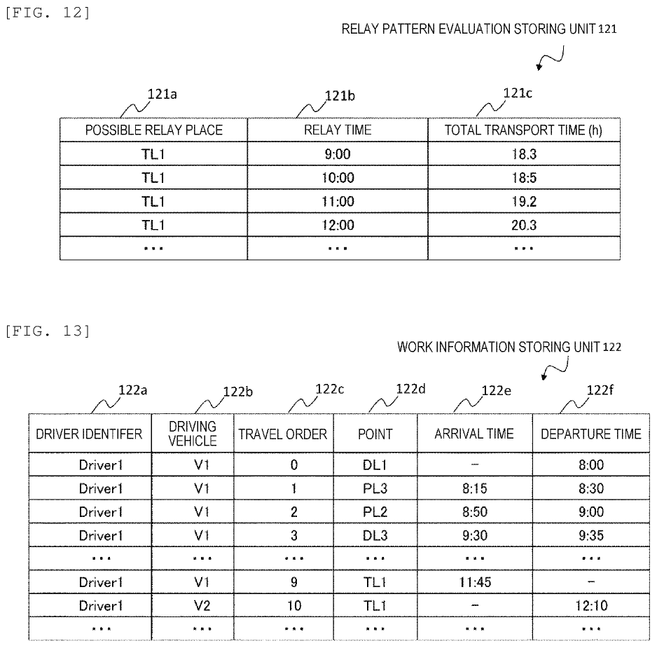

FIG. 11 is a diagram illustrating a data structure example of the travel plan information storing unit. The travel plan information storing unit 120 includes a vehicle identifier 120a, a travel order 120b, a point 120c, an arrival time 120d, and a departure time 120e.

The vehicle identifier 120a is an identifier that distinguishes one vehicle from other vehicles. The travel order 120b is an order in which the vehicle specified by the vehicle identifier 120a travels. The point 120c is a point at which the vehicle specified by the vehicle identifier 120a stops. The arrival time 120d and the departure time 120e are a time when the vehicle specified by the vehicle identifier 120a arrives at the point specified by the point 120c and a time when the vehicle departs from the point after completion of a requirement such as collection, delivery, or relay, respectively.

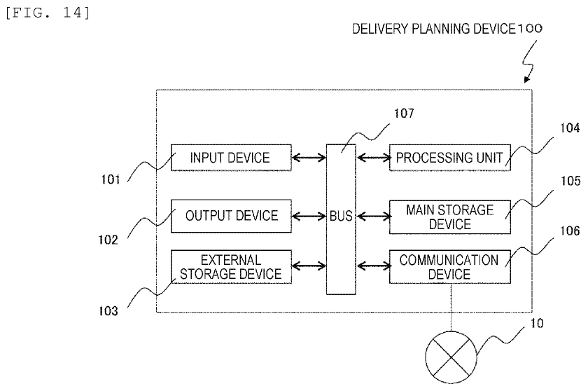

FIG. 12 is a diagram illustrating a data structure example of the relay pattern evaluation storing unit. The relay pattern evaluation storing unit 121 includes a possible relay place 121a, a relay time 121b, and a total transport time 121c.

The possible relay place 121a is information for specifying a candidate for a relay place. The relay time 121b is information for specifying a target time when relay is performed. The total transport time 121c stores a shortest time required to complete deliveries of all cargos as delivery targets when the candidate for the relay place is specified by the possible relay place 121a and relay is performed at the time specified by the relay time 121b.

FIG. 13 is a diagram illustrating a data structure example of the work information storing unit. The work information storing unit 122 includes a driver identifier 122a, a driving vehicle 122b, a travel order 122c, a point 122d, an arrival time 122e, and a departure time 122f.

The driver identifier 122 is an identifier that distinguishes one driver from other drivers. The driving vehicle 122b is information for specifying a vehicle that is driven by the driver specified by the driver identifier 122a. The travel order 122c is an order in which the driving vehicle specified by the driving vehicle 122b travels. The point 122d is a point at which the vehicle specified by the driving vehicle 122b stops. The arrival time 122e and the departure time 122f are a time when the vehicle specified by the driving vehicle 122b arrives at the point specified by the point 122d and a time when the vehicle departs from the point after completion of a requirement such as collection, delivery, or relay, respectively.

The description of FIG. 1 will be made again. The delivery request registering unit 131 of the controller 130 receives and registers one or more delivery requests relating to deliveries between predetermined points.

The responsible area generating unit 132 generates responsible areas by dividing the delivery requests into deliveries in one or more areas for which drivers of a predetermined number of delivery vehicles are responsible according to the predetermined number of the delivery vehicles. At this time, the responsible area generating unit 132 divides the delivery requests such that the number of deliveries across the areas is minimized. The responsible area generating unit 132 divides the delivery requests by giving priority to a delivery request in which a vehicle center that store the delivery vehicles is included in the areas and the candidate for the relay place is near each of the areas. The responsible area generating unit 132 divides the delivery requests using a coefficient corresponding to a maximum cargo amount of each of the delivery vehicles and an operable time of each of the delivery vehicles, that is, regarding a delivery load.

The vehicle route planning unit 133 specifies a delivery route and a cost relating to deliveries for each combination of a candidate for a relay place between the areas and a relay time in the candidate for the relay place and specifies the delivery route as a vehicle route using the cost as an index (for example, a low cost). At this time, when each of the delivery vehicles arrives at the candidate for the relay place, the vehicle route planning unit 133 gives priority to the delivery route in which the number of cargos of in-area deliveries in which a delivery place is in a previous area is small. On the other hand, when each of the delivery vehicles does not include a cargo of an in-area delivery when arriving at the candidate for the relay place, the vehicle route planning unit 133 specifies the delivery route such that the driver who drives the delivery vehicle transfers to another delivery vehicle that arrives at the candidate for the relay place from another area and continues the delivery in the same area.

When each of the delivery vehicles arrives at the candidate for the relay place, the vehicle route planning unit 133 gives priority to the delivery route in which the number of cargos of in-area deliveries in which a delivery place is in a previous area is small, and when each of the delivery vehicles includes a cargo of an in-area delivery when arriving at the candidate for the relay place, the vehicle route planning unit specifies the delivery route such that the driver who drives the delivery vehicle selects a cargo that requires a shorter time for reloading among cargos of an in-area delivery and cargos of an inter-area delivery in which a delivery place is not in a previous area and reloads the selected cargo from another delivery vehicle in the candidate for the relay place and such that, as necessary, the drive transfers to another delivery vehicle that arrives at the candidate for the relay place from another area and continues the delivery in the same area.

When the number of areas generated by the responsible area generating unit 132 is 3 or more, the vehicle route planning unit 133 may determine a travel order of the areas of the respective delivery vehicles in advance according to the number of requests in the areas.

The on-time delivery determining unit 134 determines whether or not on-time delivery can be realized. Specifically, the on-time delivery determining unit 134 determines whether or not all the deliveries that are not excluded among the registered delivery requests can be completed within the possible delivery time zone using the vehicle route planned by the vehicle route planning unit 133 and the delivery vehicles. Alternatively, instead of exactly determining whether or not the deliveries of all the cargos can be completed within the possible delivery time zone, for example, the on-time delivery determining unit 134 may obtain an on-time delivery success ratio that is a ratio of the number of requests that can completed on time to the total number of delivery requests and, when this on-time delivery success ratio exceeds a predetermined threshold (for example, 95 percent), may determine that on-time delivery can be realized.

The driver assigning unit 135 assigns the drivers for the vehicle route specified by the vehicle route planning unit 133. Specifically, the driver assigning unit 135 assigns the drivers to the areas generated by the responsible area generating unit 132 and assigns the delivery vehicles to the drivers according to the possible working hours. It is preferable that the driver assigning unit 135 assigns the drivers such that, when the delivery vehicle arrives at the relay place, not only the transfer of the driver to another delivery vehicle but also the change of shifts between the drivers (the end of the shift of the corresponding driver and the start of the shift of another driver) are performed. When the number of the drivers assigned is more or less than the number of the delivery vehicles, the driver assigning unit 135 assigns the drivers by setting the smaller one among the number of the drivers and the number of the delivery vehicles as the upper limit. That is, even when the number of the delivery vehicles is insufficient in a certain time zone, the driver assigning unit 135 does not increase the number of the delivery vehicles, and even when the number of the drivers is insufficient in a certain time zone, the driver assigning unit 135 does not increase the number of the drivers.

The working condition determining unit 136 determines whether or not the drivers assigned by the driver assigning unit 135 satisfy working conditions. Specifically, the working condition determining unit 136 determines whether or not the working hours of each of the drivers are within maximum working hours by referring to the driver information storing unit 118.

Hereinabove, the configuration example of the delivery planning device 100 has been described. The delivery plan can be made using the delivery planning device 100, and the result and execution state thereof can be referred to from the terminal 200 for owner, the terminal 210 for vehicle, and the terminal 220 for driver.

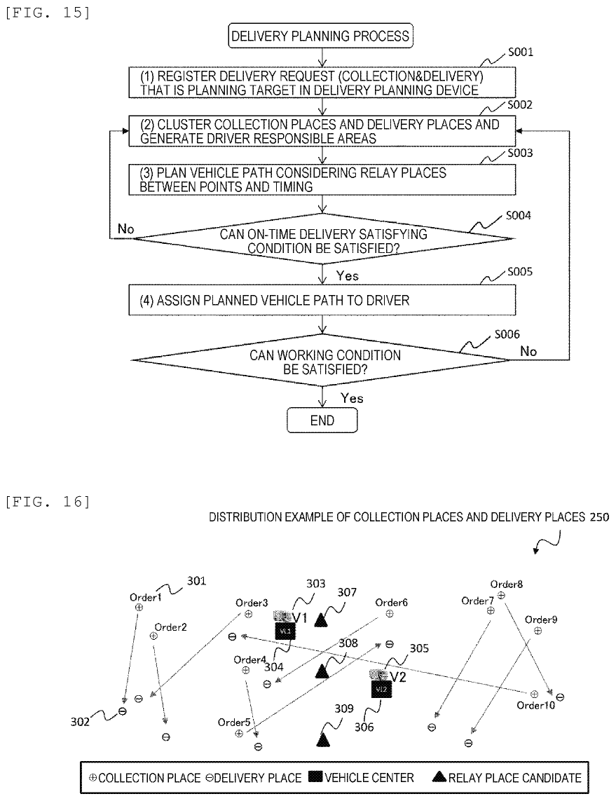

FIG. 14 is a diagram illustrating a hardware configuration example of the delivery planning device. The delivery planning device 100 can be implemented by a computer or a computer system including a plurality of the computers, the computer including: an input device 101 such as a keyboard, a mouse, a bar code reader; an output device 102 such as a display; an external storage device 103 such as a hard disk drive (HDD); a processing unit (PU) 104; a main storage device 105 such as a memory; a communication device 106; and a bus 107 that connects the components to each other.

For example, the delivery request registering unit 131, the responsible area generating unit 132, the vehicle route planning unit 133, the on-time delivery determining unit 134, the driver assigning unit 135, and the working condition determining unit 136 of the controller 130 can be implemented by loading a predetermined program stored in the external storage device 103 to the main storage device 105 and executing the loaded program using the processing unit 104. The storing unit 110 can be implemented by the processing unit 104 using the main storage device 105 or the external storage device 103.

Although not limited thereto, the delivery planning device 100 may be implemented, for example, an application specific integrated circuit (ASIC) or a microcomputer.

FIG. 15 is a diagram illustrating a flow of a delivery planning process. The delivery planning process starts, for example, in response to an instruction of an operator or at a predetermined time.

First, the delivery request registering unit 131 registers a delivery request (collection and delivery) as a planning target in the delivery planning device (Step S001). Specifically, the delivery request registering unit 131 receives one or more delivery requests between predetermined points (collection places and delivery places) and stores the received information in each item of the delivery request information storing unit 111, the collection information storing unit 112, and the delivery information storing unit 113. Here, the process priority 111f of the delivery request information storing unit 111 may be calculated using predetermined priority calculating means (not illustrated) such that, for example, the order from the earliest delivery date, the order from the earliest reception date, or the order from the largest number of loaded cargos that remain due to delivery failure is stored as the process priority.

The responsible area generating unit 132 clusters collection places and delivery places and generates driver responsible areas (Step S002). Specifically, the responsible area generating unit 132 prepares, as the driver responsible areas, a k number (k represents an integer that is more than or equal to 1 and less than the smaller one among the number of delivery vehicles in the area and the maximum number of drivers in the area) of areas including one or more vehicle centers. The reason is that, since a delivery can be performed by pairing a delivery vehicle and a driver, the number k of the areas is set not to exceed the number of pairs of delivery vehicles and drivers. As the number k decreases, the utilization of the delivery vehicles and the drivers increases. Therefore, it is recommended that the value of k is as small as possible within the range.

When the value of k is 2 or more (that is, when 2 or more areas are prepared), the responsible area generating unit 132 specifies a distance from each of collection places to each of the vehicle centers and a distance from each of delivery places to each of the vehicle centers using the moving cost information storing unit 116, compares the specified distances to each other, and assigns each of the collection places and the delivery places to an area including the nearest vehicle center. As a result, the delivery requests are divided into deliveries in the areas (nearest neighbor method).

A method of dividing the k number of areas is not limited to the nearest neighbor method. For example, K-means clustering or fuzzy c-means clustering can also be used, and a fixed area of an existing administrative district, an address-based district, or a predetermined business-related district that is set in a company may also be used.

The responsible area generating unit 132 may use a travel time as an index value instead of the above-described nearest neighbor method to assign the delivery requests to areas having the shortest travel times.

When a plurality of candidates are present for one area, the responsible area generating unit 132 preferentially adopts a candidate in which the number of inter-area delivery requests is small. The responsible area generating unit 132 generates data relating to the delivery request distribution storing unit 119 for each candidate for the area and specifies three deliveries including one delivery from the Area1 (119a) to the Area2 (119d) and two deliveries from the Area2 (119b) to the Area2 (119c) as the inter-area delivery requests.

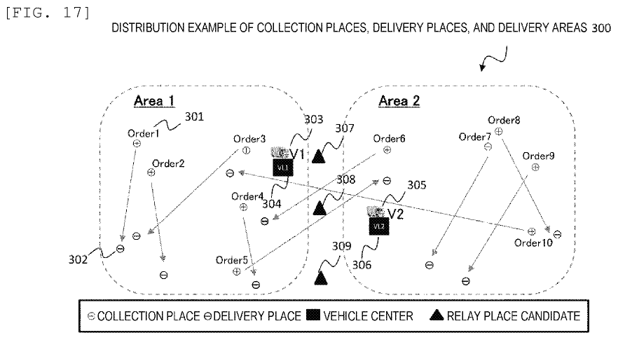

FIG. 16 is a diagram illustrating a distribution example of collection places and delivery places. In a distribution example 250 of collection places and delivery places, a point represented by a plus sign is a collection place where a cargo is to be loaded on a delivery vehicle, and a point represented by a minus symbol is a collection place where a cargo is to be delivered. A delivery vehicle V1 (303) and a delivery vehicle V2 (305) are stored in a vehicle center VL1 (304) and a vehicle center VL2 (306), and relay places 307 to 309 are present at positions different from the vehicle center VL1 (304) and the vehicle center VL2 (306).

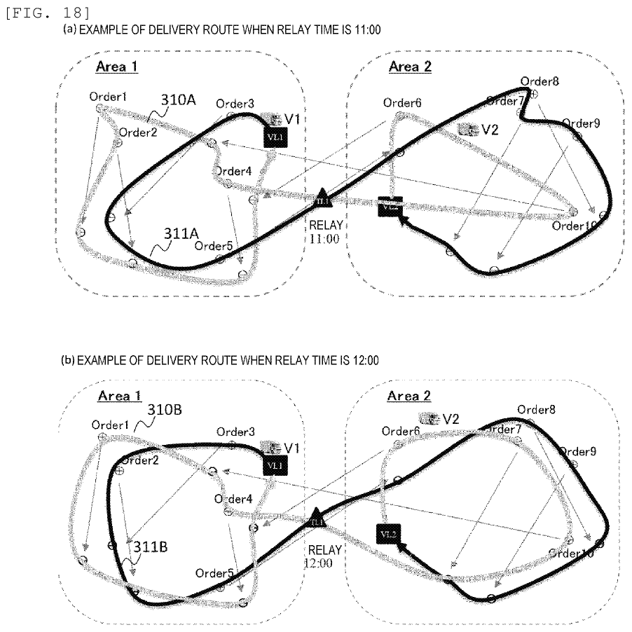

FIG. 17 is a diagram illustrating a distribution example of collection places, delivery places, and delivery areas. In a distribution example 300 of collection places, delivery places, and delivery areas of FIG. 17, in addition to the distribution example illustrated in FIG. 16, delivery areas including an Area1 and an Area2 bounded by the relay places 307 to 309 are illustrated. In this example, for example, a collection place 301 and a delivery place 302 of “Order1” are classified into the same Area1, and “Order2” to “Order4” are also in-area transports. Likewise, “Order7” to “Order9” are also in-area transports of the Area2.

However, each of “Order5”, “Order6”, and “Order10” is an inter-area transport across the areas without being completed in one area.

In these examples, administrative districts or areas predetermined by a delivery company may be used. However, delivery requests have fluidity in that they change every day. Therefore, when predetermined areas are used, the number of inter-area transports increase, cargos are frequently reloaded, and the transport efficiency may decrease. Therefore, it cannot be said that the use of predetermined areas is always appropriate.

There are a plurality of options for performing relay at any time in any of the relay places 307 to 309, and the efficient delivery order in each area may also change depending on which option is selected.

Each of the relay places 307 to 309 may be a facility such as a vehicle center or a maintenance factory of a delivery company or may be an external resource such as a gas station or a parking area (if permission is required, a permitted place).

When deliveries are unevenly distributed in some areas, a high load may be applied to a driver. Therefore, considering this point, candidates for the areas may be compared to each other. For example, considering the delivery capacity of a delivery vehicle belonging to an area and the possible working hours of a driver, the responsible area generating unit 132 may calculate the product of the vehicle maximum cargo amount and the working hours of the driver as a load factor and may adopt a candidate for the area having a low bias of the load factor.

The vehicle route planning unit 133 plans a vehicle route in consideration of a relay place between areas and a timing (Step S003). Specifically, the vehicle route planning unit 133 specifies candidates for the relay place and the relay time where drivers can exchange between adjacent areas and cargos can be smoothly transported. The vehicle route planning unit 133 specifies a travel route for delivering cargos in the areas before and after relay for each candidate for the relay place and the relay time.

The vehicle route planning unit 133 can specify this travel route using various methods. Examples of the methods include Nearest Neighbor Search and Dijkstra's algorithm. A return place of a delivery vehicle is an initial delivery start position of the driver. That is, irrespective of whether or not the delivery vehicle is changed by relay, the delivery vehicle returns to an initial start position of the travel route of the driver.

FIG. 18 is a diagram illustrating examples of vehicle routes depending on relay times. FIG. 18 comparatively illustrates (a) an example of a delivery route where the relay time is 11:00 and (b) an example of a delivery route where the relay time is 12:00. The example (a) and the example (b) are the same in conditions such as the areas, the delivery vehicles, the drivers, the delivery requests, and the relay places and are different in conditions such as the relay time in the relay place.

In a delivery route 310A of the delivery vehicle V2 in the example (a), the driver of the Area2 gets into the delivery vehicle V2 in the vehicle center VL2 and collects “Order6” and “Order10”. Next, the driver of the delivery vehicle V2 is changed to the driver of the Area1 through relay at 11:00 in the relay place TL1. Next, the driver of the Area1 performs the collection of “Order4”, the delivery of “Order10”, the collection of “Order1”, the collection of “Order2”, the delivery of “Order1”, the delivery of “Order2”, the delivery of “Order4”, and the delivery of “Order6” in this order, returns to the vehicle center VL1, and ends the delivery.

In a delivery route 310B of the delivery vehicle V2 in the example (a), the driver of the Area2 gets into the delivery vehicle V2 in the vehicle center VL2 and collects “Order6”, “Order7”, and “Order10” and delivers “Order7”. Next, the driver of the delivery vehicle V2 is changed to the driver of the Area1 through relay at 12:00 in the relay place TL1. Next, the driver of the Area1 performs the collection of “Order4”, the delivery of “Order10”, the collection of “Order1”, the delivery of “Order1”, the delivery of “Order4”, the delivery of “Order6” in this order, returns to the vehicle center VL1, and ends the delivery.

Likewise, in a delivery route 311B of the delivery vehicle V1 in the example (a), the driver of the Area1 gets into the delivery vehicle V1 in the vehicle center VL1 and performs the collection of “Order3”, the delivery of “Order3”, and the collection of “Order5”. Next, the driver of the delivery vehicle V1 is changed to the driver of the Area2 through relay at 11:00 in the relay place TL1. Next, the driver of the Area2 performs the delivery of “Order5”, the collection of “Order8”, “Order7”, and “Order9”, the delivery of “Order8”, the delivery of “Order9”, and the delivery of “Order7” in this order, returns to the vehicle center VL2, and ends the delivery.

In a delivery route 311B of the delivery vehicle V1 in the example (a), the driver of the Area1 gets into the delivery vehicle V1 in the vehicle center VL1 and performs the collection of “Order3” and “Order2”, the delivery of “Order3” and “Order2”, and the collection of “Order5”. Next, the driver of the delivery vehicle V1 is changed to the driver of the Area2 through relay at 12:00 in the relay place TL1. Next, the driver of the Area2 performs the delivery of “Order5”, the collection of “Order8” and “Order9”, and the delivery of “Order8” and “Order9” in this order, returns to the vehicle center VL2, and ends the delivery.

In this way, when the relay time changes under the condition that the relay place is the same, the optimal delivery route changes. In this case, when each of the delivery vehicles arrives at the candidate for the relay place, the vehicle route planning unit 133 gives priority to a delivery route in which the number of cargos of in-area deliveries in which a delivery place is in a previous area is small. On the other hand, when each of the delivery vehicles does not include a cargo of an in-area delivery when arriving at the candidate for the relay place, the vehicle route planning unit 133 specifies the delivery route such that the driver who drives the delivery vehicle transfers to another delivery vehicle that arrives at the candidate for the relay place from another area and continues the delivery in the same area.

When each of the delivery vehicles arrives at the candidate for the relay place, the vehicle route planning unit 133 gives priority to the delivery route in which the number of cargos of in-area deliveries in which a delivery place is in a previous area is small, and when each of the delivery vehicles includes a cargo of an in-area delivery when arriving at the candidate for the relay place, the vehicle route planning unit specifies the delivery route such that the driver who drives the delivery vehicle selects a cargo that requires a shorter time for reloading among cargos of an in-area delivery and cargos of an inter-area delivery in which a delivery place is not in a previous area and reloads the selected cargo from another delivery vehicle in the candidate for the relay place and such that, as necessary, the drive transfers to another delivery vehicle that arrives at the candidate for the relay place from another area and continues the delivery in the same area.

For example, as the candidates for the relay place and the relay time, combinations of relay places (for example, TL1, TL2, and TL3) and predetermined relay times (10:00, 11:00, 12:00, 13:00, 14:00, and 15:00) can be assumed. Regarding each of the candidates, the vehicle route planning unit 133 specifies delivery routes of the respective delivery vehicles, transport times required for the travels, and a total transport time which is the sum of the transport times of all the delivery vehicles. Regarding the information of the delivery route, the vehicle route planning unit 133 stores the travel order, the arrival time, and the departure time in the travel plan information storing unit 120 in units of points.

The vehicle route planning unit 133 stores the total transport time which is calculated for each candidate for the relay place and the relay time in the relay pattern evaluation storing unit 121. The vehicle route planning unit 133 determines that a candidate for the relay place and the relay time having the shortest total transport time is the optimum, and plans the delivery route of the candidate as the vehicle route in consideration of the relay place between areas and the timing.

In the process of specifying the delivery route, the vehicle route planning unit 133 can further set a vehicle capacity, a possible collection time zone, and a possible delivery time zone as restriction conditions.

The on-time delivery determining unit 134 determines whether or not on-time delivery can be realized (Step S004). Specifically, the on-time delivery determining unit 134 calculates the on-time delivery success ratio to determine whether or not the on-time delivery success ratio exceeds a predetermined threshold.

When on-time delivery cannot be realized (“NO” in Step S004), the on-time delivery determining unit 134 increments the value of k within a range not exceeding the upper limit, that is, increases the number of areas and returns the control to Step S002. By increasing the value of k, the areas can be finely divided, and the number of deliveries per area can be reduced. When the value of k cannot be increased because it is the same as the upper limit, that is, the smaller one among the number of delivery vehicles in the area and the maximum number of drivers in the target area, the on-time delivery determining unit 134 delays one delivery request having a low process priority to the next day or later and returns the control to Step S002. By reducing the number of deliveries, the number of deliveries per area can be reduced.

When on-time delivery can be realized (“Yes” in Step S004), the driver assigning unit 135 assigns drivers to the planned vehicle route (Step S005). Specifically, the driver assigning unit 135 assigns the drivers to the areas generated by the responsible area generating unit 132 and assigns the delivery vehicles to the drivers according to the possible working hours. It is preferable that the driver assigning unit 135 assigns the drivers such that, when the delivery vehicle arrives at the relay place, not only the transfer of the driver to another delivery vehicle but also the change of shifts between the drivers (the end of the shift of the corresponding driver and the start of another driver) are performed. When the number of the drivers assigned is more or less than the number of the delivery vehicles, the driver assigning unit 135 assigns the drivers by setting the smaller one among the number of the drivers and the number of the delivery vehicles as the upper limit.

The working condition determining unit 136 determines whether or not working conditions can be satisfied (Step S006). Specifically, the working condition determining unit 136 determines whether or not the working hours of each of the drivers assigned by the driver assigning unit 135 are within maximum working hours by referring to the driver information storing unit 118. When the working conditions can be satisfied (“Yes” in Step S006”), the working condition determining unit 136 ends the delivery planning process.

When the working conditions cannot be satisfied (“No” in Step S006), the working condition determining unit 136 returns the control to Step S002. At this time, the working condition determining unit 136 increases the value of k within a range not exceeding the upper limit, that is, increases the number of areas and returns the control to Step S002. By increasing the value of k, the areas can be finely divided, and the number of deliveries per area can be reduced. When the value of k cannot be increased because it is the same as the upper limit, that is, the smaller one among the number of delivery vehicles in the area and the maximum number of drivers in the target area, the on-time delivery determining unit 134 delays one delivery request having a low process priority to the next day or later and returns the control to Step S002. By reducing the number of deliveries, the number of deliveries per area can be reduced.

Hereinabove, the flow of the delivery planning process has been described. According to the delivery planning process, it is possible to realize a device, a system, and a method that efficiently deal with delivery requirements where a loading place, an off-loading place, a cargo amount, a car loading vehicle, and a work shift of a driver fluidly change.

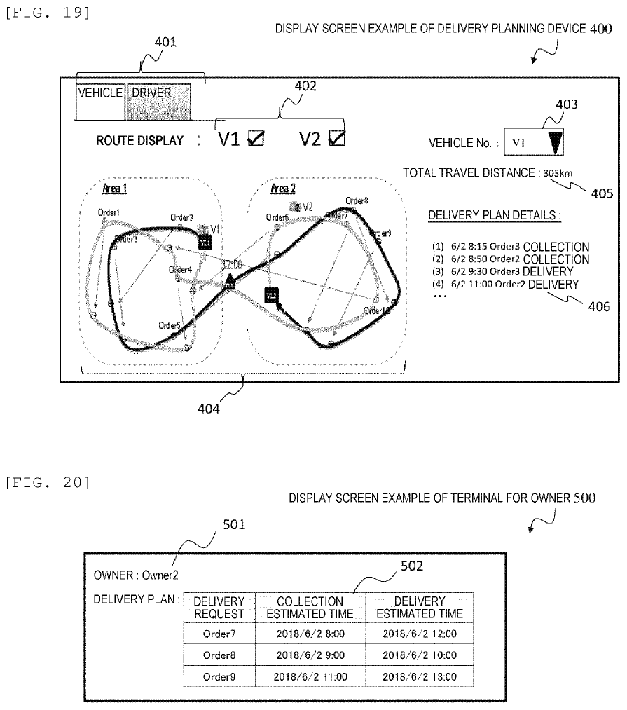

FIG. 19 is a diagram illustrating a display screen example of the delivery planning device. A display screen 400 of the delivery planning device is a screen example that displays the vehicle route obtained as a result of the delivery planning process for a delivery vehicle or a driver. The display screen 400 of the delivery planning device includes: a tab 401 that can select a screen for a delivery vehicle or a screen for a driver; a check box 402 that receives selection of multiple targets for a route display; a select box 403 that receives exclusive selection of a target to display the details of the vehicle route; a map display region 404 that displays the selected vehicle route to overlap a sketch map; a total travel distance display region 405 that displays a total travel distance of the exclusively selected vehicle; and a delivery plan detail display region 406 that displays estimated dates and times of collection and delivery of the exclusively selected vehicle in a chronological manner.

The tab 401 can switch between the display for a delivery vehicle and the display for a driver. When an input is received to perform the display for a delivery vehicle, the display is as illustrated in the drawing. Although not illustrated in the drawing, when an input is received to perform the display for a driver, a map of a moving path, a total travel distance, and delivery plan details are displayed per driver.

The check box 402 displays a list of delivery vehicles and receives selection of multiple delivery vehicles whose vehicle routes are to be displayed on the map display region 404. When multiple delivery vehicles are selected in the check box 402, the vehicle routes of the corresponding delivery vehicles are displayed to overlap the map display region 404.

The select box 403 alternatively displays the delivery vehicles as choices and receives selection of any one of the delivery vehicles, the total travel distance display region 405 and the delivery plan detail display region 406 updates the information of the corresponding delivery vehicle and displays the updated information.

FIG. 20 is a diagram illustrating a display screen example of the terminal for owner. A display screen example 500 of the terminal for owner includes an owner display region 501 and a delivery plan display region 502. The owner display region 501 displays, for example, an identifier or a nickname of an owner. The delivery plan display region 502 displays a collection estimated time (when the collection is completed, the collection time) and a delivery estimated time (when the delivery is completed, the delivery time) for each delivery request.

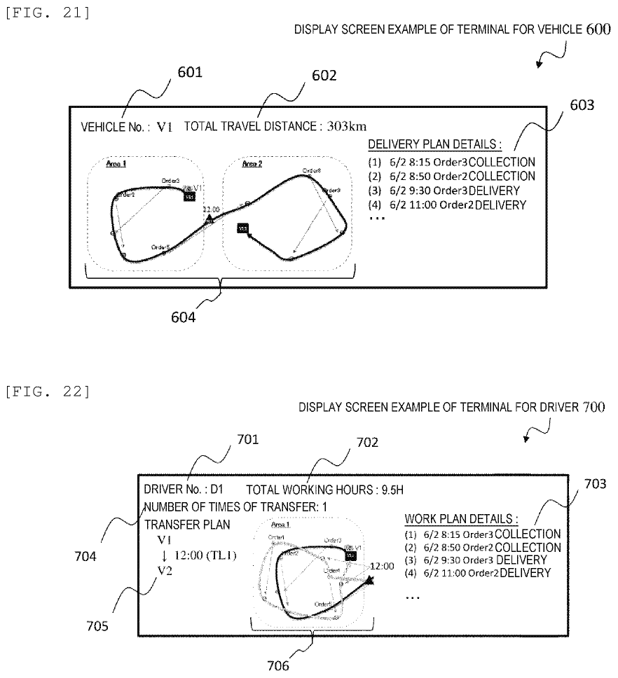

FIG. 21 is a diagram illustrating a display screen example of the terminal for vehicle. A display screen example 600 of the terminal for vehicle includes a vehicle identifier display region 601, a total travel distance display region 602, a delivery plan detail display region 603, and a map display region 604.

The vehicle identifier display region 601 displays a vehicle identifier. The total travel distance display region 602 displays a total travel distance of a delivery vehicle. The delivery plan detail display region 603 displays estimated dates and times of collection and delivery of a delivery vehicle in a chronological manner regardless of driver. The map display region 604 displays a vehicle route of a delivery vehicle on which the terminal 210 for vehicle is mounted to overlap on a sketch map.

FIG. 22 is a diagram illustrating a display screen example of the terminal for driver. A display screen example 700 of the terminal for driver includes a driver identifier display region 701, a total working hour display region 702, a work plan detail display region 703, a number of times of transfer 704, a transfer plan 705, and a map display region 706.

The driver identifier display region 701 displays a driver identifier. The total working hour display region 702 displays total working hours of the day of a driver who uses the terminal for driver irrespective of a delivery vehicle. The work plan detail display region 703 displays estimated dates and times of collection and delivery of a driver in a chronological manner regardless of delivery vehicle. The number of times of transfer 704 displays the number of times in which a driver transfers to a delivery vehicle in a relay place. The transfer plan 705 displays a relay place where a driver transfers to a delivery vehicle and the relay time thereof in a chronological manner. The map display region 706 displays a moving path of each of delivery vehicles of a driver to overlap a sketch map of a responsible area.

Hereinabove, the embodiment of the present invention has been described. According to the embodiment, it is possible to realize a device, a system, and a method that efficiently deal with delivery requirements where a loading place, an off-loading place, a cargo amount, a car loading vehicle, and a work shift of a driver fluidly change.

The present invention is not limited to the embodiment and includes various modification examples. For example, the embodiments have been described in detail in order to easily describe the present invention, and the present invention is not necessarily to include all the configurations described above.

Addition, deletion, and replacement of another configuration can be made for a part of the configuration of the embodiment.

Some or all of the above-described respective configurations, functions, processing units, and the like may be realized by hardware, for example, by designing an integrated circuit. The respective configurations, functions, and the like may be realized by software control by a processor executing an operation according to a program that realizes each of the functions. The information in the programs, tables, and files for executing the functions may be stored in a recording device such as a memory, a hard disk, an SSD, or a recording medium such as an IC card, an SD card, or a DVD and can be read to a random access memory (RAM) or the like during execution to be executed by a CPU or the like.

The drawings illustrate control lines or information lines as considered necessary for explanations but do not illustrate all control lines or information lines in the products. It can be considered that almost of all the components are actually interconnected.

Some or all of the above-described respective configurations, functions, processing units, and the like may be realized by a distribution system, for example, by being executed using another device and being integrally processed through a network.

Technical elements of the above-described embodiment maybe individually applied, or may be divided into a plurality of portions such as a program component and a hardware component to be applied.

Hereinabove, the embodiment has been mainly described regarding the present invention.

### REFERENCE SIGNS LIST

10: network

100: delivery planning device

110: storing unit

111: delivery request information storing unit

112: collection information storing unit

113: delivery information storing unit

114: vehicle center information storing unit

115: relay place information storing unit

116: moving cost information storing unit

117: vehicle information storing unit

118: driver information storing unit

119: delivery request distribution storing unit

120: travel plan information storing unit

121: relay pattern evaluation storing unit

122: work information storing unit

130: controller

131: delivery request registering unit

132: responsible area generating unit

133: vehicle route planning unit

134: on-time delivery determining unit

135: driver assigning unit

136: working condition determining unit

141: input unit

142: output unit

143: communication unit

200: terminal for owner

210: terminal for vehicle

220: terminal for driver

1. A delivery planning device comprising:
a delivery request registering unit that receives and registers one or more delivery requests relating to deliveries between predetermined points;
a responsible area generating unit that divides the delivery requests into deliveries in one or more areas for which drivers of a predetermined number of delivery vehicles are responsible according to the predetermined number of the delivery vehicles; and
a vehicle route planning unit that specifies a delivery route and a cost relating to deliveries for each combination of a candidate for a relay place between the areas and a relay time in the candidate for the relay place and specifies the delivery route as a vehicle route using the cost.

2. The delivery planning device according to claim 1, wherein
the responsible area generating unit divides the delivery requests such that the number of deliveries across the areas is minimized.

3. The delivery planning device according to claim 1, wherein
the responsible area generating unit divides the delivery requests by giving priority to a delivery request in which vehicle centers that store the delivery vehicles are included in the areas and the candidate for the relay place is near each of the areas.

4. The delivery planning device according to claim 1, wherein
the responsible area generating unit divides the delivery requests using a coefficient corresponding to a maximum cargo amount of each of the delivery vehicles and an operable time of each of the delivery vehicles.

5. The delivery planning device according to claim 1, wherein
the responsible area generating unit divides the delivery requests using a fixed unit of an existing administrative district, an address-based district, or a predetermined business-related district.

6. The delivery planning device according to claim 1, wherein
the vehicle route planning unit specifies the delivery route having a low cost as the vehicle route.

7. The delivery planning device according to claim 1, wherein
the vehicle route planning unit gives priority to the delivery route in which the number of cargos of in-area deliveries in which a delivery place is in a previous area is small when each of the delivery vehicles arrives at the candidate for the relay place.

8. The delivery planning device according to claim 1, wherein
the vehicle route planning unit gives priority to the delivery route in which the number of cargos of in-area deliveries in which a delivery place is in a previous area is small when each of the delivery vehicles arrives at the candidate for the relay place, and
when each of the delivery vehicles does not include a cargo of an in-area delivery when arriving at the candidate for the relay place, the vehicle route planning unit calculates the delivery route such that the driver who drives the delivery vehicle transfers to another delivery vehicle that arrives at the candidate for the relay place from another area and continues the delivery in the same area.

9. The delivery planning device according to claim 1, wherein
the vehicle route planning unit gives priority to the delivery route in which the number of cargos of in-area deliveries in which a delivery place is in a previous area is small when each of the delivery vehicles arrives at the candidate for the relay place, and
when each of the delivery vehicles includes a cargo of an in-area delivery when arriving at the candidate for the relay place, the vehicle route planning unit calculates the delivery route such that the driver who drives the delivery vehicle selects a cargo that requires a shorter time for reloading among cargos of an in-area delivery and cargos of an inter-area delivery in which a delivery place is not in a previous area and reloads the selected cargo from another delivery vehicle in the candidate for the relay place and such that, as necessary, the driver transfers to another delivery vehicle that arrives at the candidate for the relay place from another area and continues the delivery in the same area.

10. The delivery planning device according to claim 1, further comprising:
a working condition determining unit that determines whether or not the delivery route is executable within working hours of the driver, wherein
when the delivery route is not executable within the working hours of the driver, the working condition determining unit specifies a delivery route different from the corresponding vehicle route as a vehicle route.

11. A delivery planning system comprising:
a server device; and
a driver terminal, wherein
the server device includes
a delivery request registering unit that receives and registers one or more delivery requests relating to deliveries between predetermined points,
a responsible area generating unit that divides the delivery requests into deliveries in one or more areas for which drivers of a predetermined number of delivery vehicles are responsible according to the predetermined number of the delivery vehicles, and
a vehicle route planning unit that specifies a delivery route and a cost relating to deliveries for each combination of a candidate for a relay place between the areas and a relay time in the candidate for the relay place and specifies the delivery route as a vehicle route using the cost, and
the driver terminal includes
a receiving unit that receives an order of movement in a responsible area in the delivery route from the server device, and
a display unit that displays a collection time and a delivery time as a work plan on a map according to the order of movement.

12. A delivery planning method using a computer device, wherein
the computer device includes a controller, and
the controller executes
a delivery request registering step of receiving and registering one or more delivery requests relating to deliveries between predetermined points,
a responsible area generating step of dividing the delivery requests into deliveries in one or more areas for which drivers of a predetermined number of delivery vehicles are responsible according to the predetermined number of the delivery vehicles, and
a vehicle route planning step of specifying a delivery route and a cost relating to deliveries for each combination of a candidate for a relay place between the areas and a relay time in the candidate for the relay place and specifying the delivery route as a vehicle route using the cost.
